(19) United States
(12) Patent Application Publication
(10) Pub. No.: US 2026/0322322 A1
(43) Pub. Date: Oct. 15, 2026

(54) REMOVAL OF SNOW FROM SOLAR PANELS USING ELECTROMECHANICAL AND ELECTROMAGNETIC FORCE

(71) Applicant: INTERNATIONAL BUSINESS MACHINES CORPORATION, ARMONK, NY (US)

(72) Inventors: Sarbajit Kumar Rakshit, Kolkata (IN); Jagabondhu Hazra, Bangalore (IN); Manikandan Padmanaban, Chennai (IN)

(21) Appl. No.: 19/179,205

(22) Filed: Apr. 15, 2025

(51) Int. Cl. H02S 40/12; H02S 20/30

(52) U.S. Cl. CPC H02S 40/12; H02S 20/30

(57) ABSTRACT

An embodiment for removing snow is provided. The embodiment may include receiving real-time and historical data. The embodiment may also include computing snow accumulation on solar panels. The embodiment may further include causing an orientation angle to change. The embodiment may also include executing a simulation of digital twin models of a first devices generating a crack in an accumulated snow by emitting a laser beam on a portion of the solar panels at a first energy level and a second device generating heat at a location of the crack at a first heating level. The embodiment may further include, based on determining a propagation pattern of the one or more cracks does not result in the accumulated snow failing to fall from at least one solar panel of the one or more solar panels, causing the one or more first devices to generate the one or more cracks.

### BACKGROUND

The present invention relates generally to the field of computing, and more particularly to a system for removing snow from solar panels using electromechanical and electromagnetic force.

In recent years, solar panels have become popular sources of renewable energy. Suitable for both home and business use, solar panels are at the forefront of the fight to combat climate change. These solar panels can power anything from batteries to massive stadiums. Additionally, solar farms have become common to provide power to cities from long distances. These solar panels are often movable, allowing them to continue to provide power regardless of the angle of the sun.

### SUMMARY

According to one embodiment, a method, computer system, and computer program product for removing snow from solar panels using electromechanical and electromagnetic force is provided. The embodiment may include receiving real-time and historical data from one or more sources in a solar panel environment. The embodiment may also include computing an amount of snow accumulation on one or more solar panels based on the real-time data. The embodiment may further include causing an orientation angle of the one or more solar panels to change to a maximum orientation angle based on the amount of snow accumulation. The embodiment may also include executing a digital twin simulation of a first digital twin model of one or more first devices generating one or more cracks in an accumulated snow by emitting a laser beam on one or more portions of the one or more solar panels at a first energy level and a second digital twin model of one or more second devices generating heat at a location of the one or more cracks at a first heating level based on the historical data. The embodiment may further include, based on determining a propagation pattern of the one or more cracks does not result in the accumulated snow failing to fall from at least one solar panel of the one or more solar panels, causing the one or more first devices to generate the one or more cracks in the accumulated snow on the one or more portions of the one or more solar panels by emitting the laser beam at the first energy level in accordance with the digital twin simulation.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for removing snow from solar panels using electromechanical and electromagnetic force in a snow removal process according to at least one embodiment.

FIG. 3 is an exemplary diagram depicting a first device emitting a laser beam onto snow-covered solar panels according to at least one embodiment.

FIG. 4 is an exemplary diagram depicting a second device applying heat to particular locations on the snow-covered solar panels according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for removing snow from solar panels using electromechanical and electromagnetic force. The following described exemplary embodiments provide a system, method, and program product to, among other things, execute a digital twin simulation of a digital twin model of one or more first devices generating one or more cracks in an accumulated snow on one or more portions of the one or more solar panels at an energy level and one or more infrared (IR) heaters generating heat at a location of the one or more cracks at a heating level based on real-time and historical data and, accordingly, causing the one or more first devices to generate the one or more cracks in the accumulated snow on the one or more portions of the one or more solar panels by emitting the laser beam at the energy level and the one or more second devices to generate the heat at the location of the one or more cracks at the heating level in accordance with the digital twin simulation. Therefore, the present embodiment has the capacity to improve solar technology by reducing energy requirements to clear snow from solar panels.

As previously described, in recent years, solar panels have become popular sources of renewable energy. Suitable for both home and business use, solar panels are at the forefront of the fight to combat climate change. These solar panels can power anything from batteries to massive stadiums. Additionally, solar farms have become common to provide power to cities from long distances. These solar panels are often movable, allowing them to continue to provide power regardless of the angle of the sun. Accumulated snow on the solar panels can damage the solar panels as well as prevent the solar panels from operating (e.g., generate electricity). This problem is typically addressed by heating the solar panels to melt the snow and/or vibrating the solar panels to remove the snow. However, heating the solar panels in this requires an extensive amount of energy and vibrating the solar panels can cause even further damage.

It may therefore be imperative to have a system in place to remove snow from solar panels with minimal energy. Thus, embodiments of the present invention may provide advantages including, but not limited to, reducing energy requirements to clear snow from solar panels, offering renewable energy solutions for solar farms, and utilizing natural forces to assist in the snow removal. The present invention does not require that all advantages need to be incorporated into every embodiment of the invention.

According to at least one embodiment, when anticipating snow in a given area, real-time and historical data may be received in order to compute an amount of snow accumulation on one or more solar panels based on the real-time data. Upon computing the amount of snow accumulation, an orientation angle of the one or more solar panels may be caused to change to a maximum orientation based on the amount of snow accumulation so that a digital twin simulation of a first digital twin model of one or more first devices generating one or more cracks in the accumulated snow by emitting a laser beam on one or more portions of the one or more solar panels at a first energy level and a second digital model of one or more second devices generating heat at a location of the one or more cracks at a first heating level based on the historical data may be executed. According to at least one embodiment, based on determining a propagation pattern of the one or more cracks does not result in the accumulated snow failing to fall, the one or more first devices may be caused to generate the one or more cracks in the accumulated snow on the one or more portions of the one or more solar panels by emitting the laser beam at the first energy level and the one or more second devices may be caused to generate the heat at the location of the one or more cracks at the first heating level in accordance with the digital twin simulation.

According to at least one other embodiment, based on determining the propagation pattern of the one or more cracks does result in the accumulated snow failing to fall, an iterative process may be performed, until the propagation pattern does not result in the accumulated snow failing to fall, where an updated digital twin simulation in which at least one operational parameter of at least one device of the one or more first devices and the one or more second devices is modified may be executed. In either embodiment, the one or more solar panels may be caused to retract from the maximum orientation angle to the orientation angle based on determining the accumulated snow has fallen from the one or more solar panels.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to execute a digital twin simulation of a digital twin model of one or more first devices generating one or more cracks in an accumulated snow on one or more portions of the one or more solar panels at an energy level and one or more IR heaters generating heat at a location of the one or more cracks at a heating level based on real-time and historical data and, accordingly, causing the one or more first devices to generate the one or more cracks in the accumulated snow on the one or more portions of the one or more solar panels by emitting the laser beam at the energy level and the one or more second devices to generate the heat at the location of the one or more cracks at the heating level in accordance with the digital twin simulation.

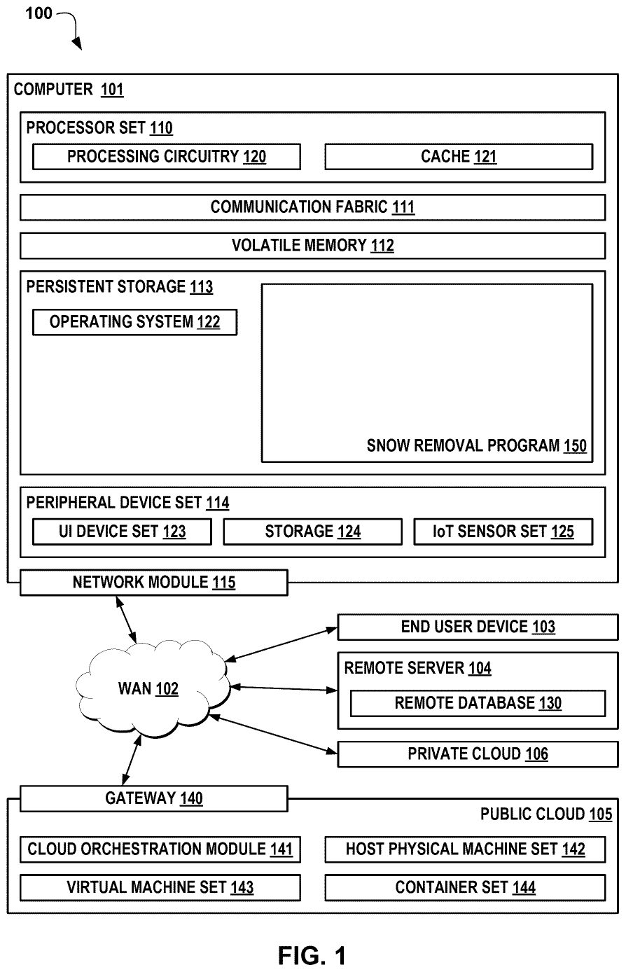

Referring to FIG. 1, an exemplary computing environment 100 is depicted, according to at least one embodiment. Computing environment 100 contains an example of an environment for the execution of at least some of the computer code involved in performing the inventive methods, such as a snow removal program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include solar panels, laser beam emitting devices, IR heating devices, and/or drones.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

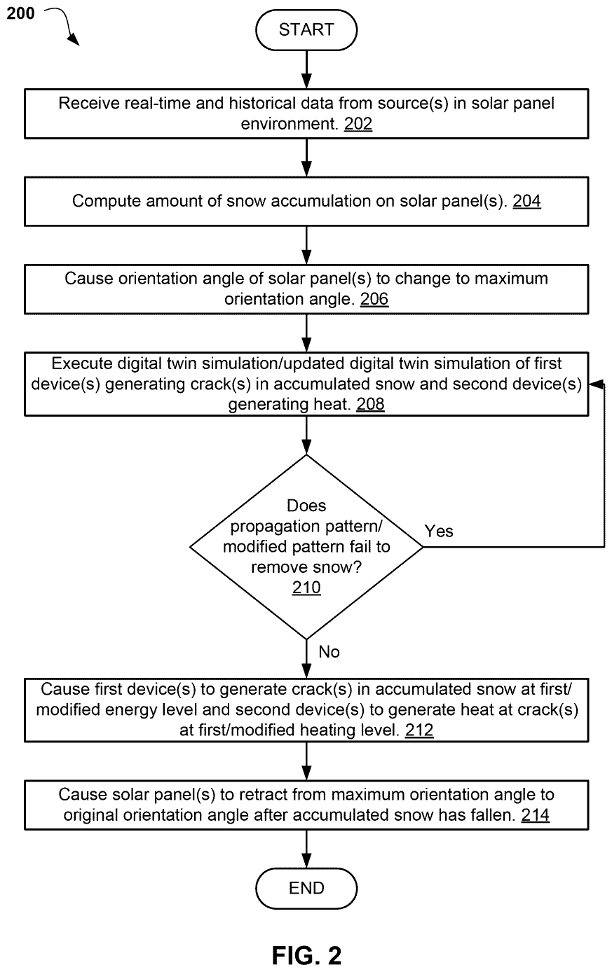

According to the present embodiment, the snow removal program 150 may be a program capable of receiving real-time and historical data from one or more sources in a solar panel environment, executing a digital twin simulation of a digital twin model of one or more first devices generating one or more cracks in an accumulated snow on one or more portions of the one or more solar panels at an energy level and one or more IR heaters generating heat at a location of the one or more cracks at a heating level based on real-time and historical data, and causing the one or more first devices to generate the one or more cracks in the accumulated snow on the one or more portions of the one or more solar panels by emitting the laser beam at the energy level and the one or more second devices to generate the heat at the location of the one or more cracks at the heating level in accordance with the digital twin simulation. Furthermore, notwithstanding depiction in computer 101, the snow removal program 150 may be stored in and/or executed by, individually or in any combination, end user device 103, remote server 104, public cloud 105, and private cloud 106. The snow removal method is explained in further detail below with respect to FIG. 2. It may be appreciated that the examples described below are not intended to be limiting, and that in embodiments of the present invention the parameters used in the examples may be different.

Referring now to FIG. 2, an operational flowchart for removing snow from solar panels using electromechanical and electromagnetic force in a snow removal process 200 is depicted according to at least one embodiment. At 202, the snow removal program 150 receives the real-time and the historical data from the one or more sources in the solar panel environment. The solar panel environment may be any location where solar panels are used. For example, the solar panel environment may be a solar farm with a massive array of solar panels that provides electricity to a large city and/or solar panels on a roof or adjacent to a residential or commercial building. The one or more sources may include, but are not limited to, a thermometer, an anemometer, a hygrometer, a camera, and/or a knowledge corpus, such as remote database 130. Accordingly, the real-time data may include, but is not limited to, wind speed and direction, temperature, humidity, an estimated snowfall prediction, and/or an orientation of the one or more solar panels.

The historical data may include, but is not limited to, a laser beam path on the accumulated snow on the one or more solar panels, laser beam strength, temperature, snowfall thickness and characteristics, and a crack propagation pattern on the accumulated snow. For example, the snowfall characteristics may include weight and stress on the one or more solar panels, as well as whether the snowfall is typically wet or powdery. The historical data may be input into and retrieved from the knowledge corpus. In this manner, the snow removal program 150 may learn from the historical data.

Then, at 204, the snow removal program 150 computes the amount of snow accumulation on the one or more solar panels. The amount of snow accumulation is computed based on the real-time data. As described above with respect to step 202, the real-time data may include the estimated snowfall prediction. For example, the computed amount of snow accumulation may be 6-8 inches.

According to at least one embodiment, the computed amount of snow accumulation may take one or more other factors into account. For example, higher levels of humidity may contribute to less snow accumulation since humidity makes it more difficult for snowflakes to form. Continuing the example, when the humidity is expected to be high, the computed amount of snow accumulation may be reduced from 6-8 inches to 4-6 inches. In another example, high wind levels may disperse snowflakes making it more likely the snowflakes will be distributed over a wider area than a particular location. Continuing the example, when wind levels are high, the computed amount of snow accumulation may be reduced from 6-8 inches to 4-6 inches.

Next, at 206, the snow removal program 150 causes the orientation angle of the one or more solar panels to change to the maximum orientation angle. The orientation angle is changed based on the amount of snow accumulation. The snow removal program 150 may send a signal to the one or more solar panels which may activate a pivot member on the one or more solar panels to tilt the one or more solar panels. It may be appreciated that in embodiments of the present invention, the orientation angle of the one or more solar panels may be changed proactively before any snow begins to accumulate on the one or more solar panels.

The maximum orientation angle should meet the following condition: mg sin θ≥F_{f}; F_{f}=μF_{N} where F_{N} is the positive pressure of the micro-element on the photovoltaic panel (N), m is the mass of the micro-element (kg), g is the acceleration due to gravity (m/s²), θ is the placement angle of the photovoltaic panel (°), μ is the friction coefficient between the snow and the photovoltaic panel, and F_{f} is the friction between the snow and the photovoltaic panel (N). The mechanical equilibrium equation perpendicular to the direction of the photovoltaic panel is as follows: F_{N}=mg cos θ.

According to at least one embodiment, the maximum orientation angle may be a maximum angle the one or more solar panels can tilt while still being able to generate electricity. In this manner, electricity production may not be cut off during the period in which the one or more solar panels are tilted at the maximum orientation angle. For example, the maximum orientation angle may be 45°.

Then, at 208, the snow removal program 150 executes the digital twin simulation of the first digital twin model of the one or more first devices generating the one or more cracks in the accumulated snow by emitting the laser beam on the one or more portions of the one or more solar panels at the first energy level and the second digital twin model of the one or more second devices generating the heat at the location of the one or more cracks at the first heating level based on the historical data. The one or more first devices may include a laser beam emitting device connected to the one or more solar panels and/or a plurality of swarm drones capable of emitting the laser beam onto the one or more solar panels. The one or more second devices may include the one or more IR heaters. The snow removal program 150 may use known techniques to create the first digital twin and the second digital twin, and these digital twin models may be used in the digital twin simulation. The digital twins may have the same specifications the one or more first devices and the one or more second devices have in the real-world. Additionally, the digital twin model of the one or more solar panels in the digital twin simulation may have the same specifications and orientation as the one or more solar panels in the real-world. In this manner, maximum accuracy may be preserved during the digital twin simulation.

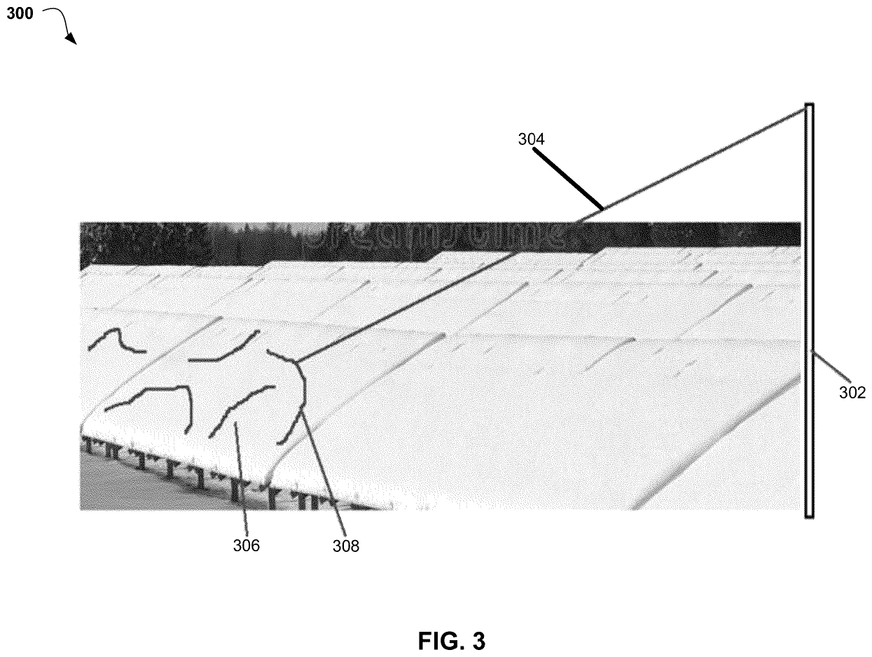

According to at least one embodiment, during the digital twin simulation, the first digital twin model may emit the laser beam on the one or more portions of the one or more solar panels at the first energy level to generate the one or more cracks, as illustrated in FIG. 3. The first energy level may be simulated based on the estimated snowfall prediction and by considering the wind speed, humidity, and temperature at the location of the solar panel environment. The first energy level may be directly proportional to the amount of snow accumulation, since more energy may be required to penetrate a thick layer of snow as opposed to a thin layer of snow. For example, where the amount of snow accumulation is estimated to be 6-8 inches, the first energy level may be 60 Watts (W), whereas when the amount of snow accumulation is estimated to be 4-6 inches, the first energy level may be 40 W. Additionally, the first energy level may be inversely proportional to the wind speed, humidity, and temperature, since these factors may reduce the amount of snow accumulation. For example, when higher humidity levels reduce the amount of snow from 6-8 inches to 4-6 inches, the first energy level may be reduced from 60 W to 40 W.

According to at least one other embodiment, the one or more portions of the one or more solar panels where the laser beam is to be emitted may be determined based on where the least amount of energy is to be applied to remove the accumulated snow from the one or more solar panels. In order to identify the one or more strategic portions of the solar panels where the energy required to be used by the laser beam is minimal, the following conditions should be met: x*=arg minx(K(x)²/E(x)G_{c}, where x is the location where the energy release rate (G(x)) for crack propagation will be close to the critical energy release rate G_{c}. One or more iterative numerical optimization techniques (e.g., gradient descent, genetic algorithms, etc.) may find the coordinates x* that maximize the crack propagation potential. The energy release rate G(x), which drives crack propagation may be G=K²/E, where K is the stress intensity factor and E is the elastic modulus of the snow. One or more crack propagation conditions apply, such as σ_{local}(x)≥σ_{c} where the local stress should be greater than critical stress, and G(x)≥G_{c} which may be the energy release criteria. The stress intensity factor may be as follows: K=σ\sqrt{πa}Y, where σ is the applied stress (ρgh), ρ is the density of the snow, g is the acceleration due to gravity, h is the thickness of the snow, a is the crack length, and Y is a dimensionless geometry factor that depends on the shape and size of the crack, as well as the loading conditions.

For example, based on the above equations, the location x where the energy release rate (G(x)) for crack propagation in the digital twin simulation will be close to the critical energy release rate G_{c} may be (4,5) where 4 may be 4 inches from a left side of a solar panel and 5 may be 5 inches from a top surface of the solar panel. Thus, at least one objective of the embodiments of the present invention is to obtain the one or more portions of the one or more solar panels where (G(x)) is as close to G_{c} as possible. Furthermore, the laser beam may be emitted outwardly from the identified coordinates along a path of the one or more solar panels. In this manner, the one or more cracks on the one or more portions of the one or more solar panels may be created.

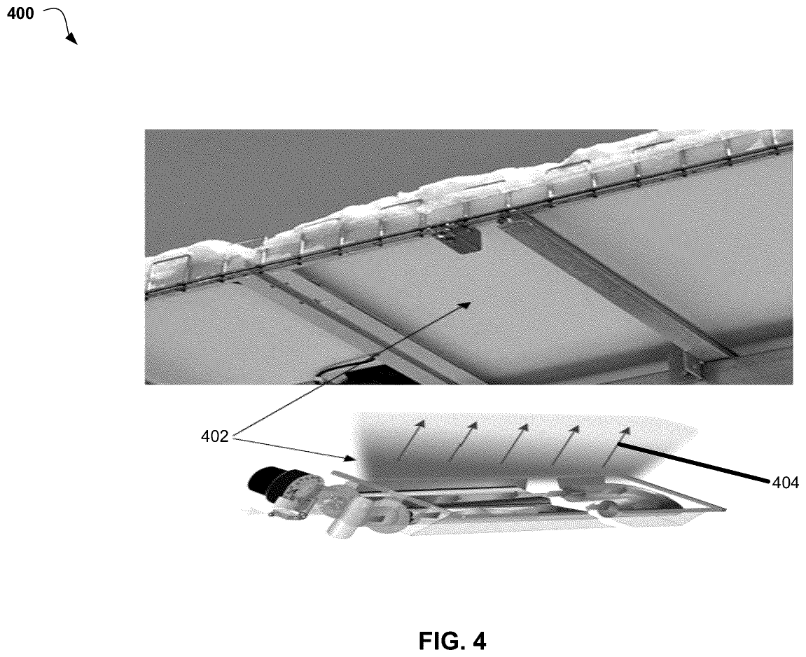

According to at least one other embodiment, during the digital twin simulation, the second digital twin model may generate the heat at the location of the one or more cracks at the first heating level to widen the one or more cracks, as illustrated in FIG. 4. It may be appreciated that in embodiments of the present invention, the one or more second devices may assist in the propagation of the one or more cracks once the laser beam is applied to the one or more cracks. The first heating level may be directly proportional to the amount of snow accumulation, since more heat may be required to propagate cracks in a thick layer of snow as opposed to a thin layer of snow. For example, where the amount of snow accumulation is estimated to be 6-8 inches, the first heating level may be 80 °F, whereas when the amount of snow accumulation is estimated to be 4-6 inches, the first heating level may be 60 °F. Additionally, the first heating level may be inversely proportional to the wind speed, humidity, and temperature, since these factors may reduce the amount of snow accumulation. For example, when higher humidity levels reduce the amount of snow from 6-8 inches to 4-6 inches, the first heating level may be reduced from 80 °F to 60 °F.

Next, at 210, the snow removal program 150 determines whether the propagation pattern of the one or more cracks results in the accumulated snow failing to fall from at least one solar panel of the one or more solar panels. The determination may be made based on the result of the digital twin simulation. In the digital twin simulation, emitting the laser beam on the one or more portions of the one or more solar panels may cause the one or more cracks to propagate from one location to another on the accumulated snow. Since the one or more solar panels are now slanted at a maximum orientation angle, the self-weight of the accumulated snow and the natural force of gravity may cause the one or more cracks to propagate and fall to the ground.

Utilizing computer vision, the snow removal program 150 may determine which solar panels the snow fell from and on which solar panels the snow remained. For the solar panels where the snow fell from, the snow removal program 150 may validate the one or more portions of the one or more solar panels, the first energy level, and the first heating level. For example, where the accumulated snow falls from “Solar panel A,” and the first energy level is 60 W, the first heating level is 80 °F, and the one or more portions are a center and top edge of “Solar panel A,” the one or more portions, the first energy level, and the first heating level may be validated. In another example, where the accumulated snow does not fall from “Solar panel B,” and the first energy level is 40 W, the first heating level is 60 °F, and the one or more portions are a lower edge of “Solar panel B,” the one or more portions, the first energy level, and the first heating level may not be validated.

Based on determining the propagation pattern does not result in the accumulated snow failing to fall (step 210, “No” branch), the snow removal process 200 proceeds to step 212 to cause the one or more first devices to generate the one or more cracks in the accumulated snow on the one or more portions of the one or more solar panels by emitting the laser beam at the first energy level in accordance with the digital twin simulation. Based on determining the propagation pattern does result in the accumulated snow failing to fall (step 210, “Yes” branch), snow removal process 200 reverts back to step 208 to execute the updated digital twin simulation.

It may be appreciated that in embodiments where the propagation pattern does result in the accumulated snow failing to fall, steps 208 and 210 may be iterated until the propagation pattern does not result in the accumulated snow failing to fall. The updated digital twin simulation may be executed where the at least one operational parameter of the at least one device of the one or more first devices and the one or more second devices is modified.

According to at least one embodiment, modifying the at least one operational parameter may include changing the first energy level to a second energy level and changing the first heating level to a second heating level. For example, the first energy level of 60 W may be increased to the second energy level of 70 W. Continuing the example, the first heating level of 80 °F may be increased to the second heating level of 90 °F.

According to at least one other embodiment, modifying the at least one operational parameter may include the changing the location of the one or more portions on the at least one solar panel. For example, the location may be changed from 4 inches from a left side of a solar panel and 5 inches from a top surface of the solar panel to 6 inches from the left side of the solar panel and 7 inches from the top surface of the solar panel.

Then, at 212, the snow removal program 150 causes the one or more first devices to generate the one or more cracks in the accumulated snow on the one or more portions of the one or more solar panels by emitting the laser beam at the first energy level in accordance with the digital twin simulation. For example, where the first energy level is 40 W and the one or more portions of the one or more solar panels are 4 inches from a left side of a solar panel and 5 inches from a top surface of the solar panel, the laser beam may be emitted at 40 W at a location 4 inches from a left side of a solar panel and 5 inches from a top surface of the solar panel, where the laser beam may be emitted outwardly from the identified coordinates along the path of the one or more solar panels. The snow removal program 150 may send a signal to the one or more first devices (e.g., laser beam emitting devices), which may supply energy to the medium of one or more first devices, which then amplifies light through stimulated emission.

According to at least one other embodiment, the snow removal program 150 causes the one or more second devices to generate the heat at the location of the one or more cracks at the first heating level in accordance with the digital twin simulation. For example, where the first heating level is 80 °F, the one or more second devices may generate the heat at 80 °F. The snow removal program 150 may send a signal to the one or more second devices (e.g., IR heaters), which may activate a heating module on the one or more second devices.

According to at least one further embodiment, where the propagation pattern does result in the accumulated snow failing to fall, the snow removal program 150 causes the one or more first devices to generate the one or more cracks in the accumulated snow on the one or more portions of the one or more solar panels by emitting the laser beam at the modified energy level (e.g., the second energy level) and causes the one or more second devices to generate the heat at the modified heating level (e.g., the second heating level) in accordance with the updated digital twin simulation. For example, where the modified energy level is 60 W and the modified heating level is 90 °F, the one or more first devices may emit the laser beam at 60 W and the one or more second devices may generate the heat at 90 °F.

Next, at 214, the snow removal program 150 causes the one or more solar panels to retract from the maximum orientation angle to the orientation angle. The one or more solar panels are retracted based on determining the accumulated snow has fallen from the one or more solar panels. Once the accumulated snow falls from the one or more solar panels, the one or more solar panels may be brought back to an original position to absorb the most sunlight as possible. The snow removal program 150 may send a signal to the one or more solar panels which may reactivate the pivot member to return the one or more solar panels to the original position.

Referring now to FIG. 3, an exemplary diagram 300 depicting a first device 302 emitting a laser beam 304 onto snow-covered solar panels 306 is shown according to at least one embodiment. In the diagram 300, the one or more first devices 302 may be a laser-beam emitting device capable of emitting the laser beam 304 onto the one or more portions of the snow-covered solar panels 306 at either the first energy level or the second energy level depending upon the results of the digital twin simulation. Specifically, the one or more first devices 302 may be attached to the snow-covered solar panels 306 to emit the laser beam 304 onto the one or more portions of the snow-covered solar panels 306. The laser beam 304 may create the one or more cracks 308 in the accumulated snow. The generated one or more cracks 308 in the accumulated snow may be discontinuous cracks. The one or more cracks 308 may be discontinuous in that the lines of the one or more cracks 308 do not touch each other. For example, there may be snow separating the one or more cracks 308.

Referring now to FIG. 4, an exemplary diagram 400 depicting a second device 402 applying heat to particular locations on the snow-covered solar panels 306 (FIG. 3) is shown according to at least one embodiment. In the diagram 400, the one or more second devices 402 may be an IR heater capable of generating the heat at the location of the one or more cracks 308 (FIG. 3) at either the first heating level or the second heating level depending upon the results of the digital twin simulation. The one or more second devices 402 may be attached beneath the snow-covered solar panels 306 (FIG. 3) to assist in the propagation of the one or more cracks 308 (FIG. 3). Arrows 404 indicate the direction of the heat upwards from beneath the snow-covered solar panels 306 (FIG. 3) at the location of the one or more cracks 308 (FIG. 3).

It may be appreciated that FIGS. 2, 3, and 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of removing snow from solar panels using electromechanical and electromagnetic force, the method comprising:
receiving real-time and historical data from one or more sources in a solar panel environment;
computing an amount of snow accumulation on one or more solar panels based on the real-time data;
causing an orientation angle of the one or more solar panels to change to a maximum orientation angle based on the amount of snow accumulation;
executing a digital twin simulation of a first digital twin model of one or more first devices generating one or more cracks in an accumulated snow by emitting a laser beam on one or more portions of the one or more solar panels at a first energy level and a second digital twin model of one or more second devices generating heat at a location of the one or more cracks at a first heating level based on the historical data;
determining whether a propagation pattern of the one or more cracks results in the accumulated snow failing to fall from at least one solar panel of the one or more solar panels; and
based on determining the propagation pattern does not result in the accumulated snow failing to fall:
causing the one or more first devices to generate the one or more cracks in the accumulated snow on the one or more portions of the one or more solar panels by emitting the laser beam at the first energy level in accordance with the digital twin simulation.

2. The computer-based method of claim 1, further comprising:
based on determining the propagation pattern does not result in the accumulated snow failing to fall:
causing the one or more second devices to generate the heat at the location of the one or more cracks at the first heating level in accordance with the digital twin simulation.

3. The computer-based method of claim 2, further comprising:
based on determining the propagation pattern does result in the accumulated snow failing to fall, iterating, until the propagation pattern does not result in the accumulated snow failing to fall:
executing an updated digital twin simulation where at least one operational parameter of at least one device of the one or more first devices and the one or more second devices is modified.

4. The computer-based method of claim 3, wherein modifying the at least one operational parameter further comprises:
changing the first energy level to a second energy level and changing the first heating level to a second heating level.

5. The computer-based method of claim 1, further comprising:
causing the one or more solar panels to retract from the maximum orientation angle to the orientation angle based on determining the accumulated snow has fallen from the one or more solar panels.

6. The computer-based method of claim 1, wherein the generated one or more cracks in the accumulated snow are discontinuous cracks.

7. The computer-based method of claim 1, wherein the one or more first devices include a plurality of swarm drones and the one or more second devices include an infrared (IR) heater.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources in a solar panel environment;
computing an amount of snow accumulation on one or more solar panels based on the real-time data;
causing an orientation angle of the one or more solar panels to change to a maximum orientation angle based on the amount of snow accumulation;
executing a digital twin simulation of a first digital twin model of one or more first devices generating one or more cracks in an accumulated snow by emitting a laser beam on one or more portions of the one or more solar panels at a first energy level and a second digital twin model of one or more second devices generating heat at a location of the one or more cracks at a first heating level based on the historical data;
determining whether a propagation pattern of the one or more cracks results in the accumulated snow failing to fall from at least one solar panel of the one or more solar panels; and
based on determining the propagation pattern does not result in the accumulated snow failing to fall:
causing the one or more first devices to generate the one or more cracks in the accumulated snow on the one or more portions of the one or more solar panels by emitting the laser beam at the first energy level in accordance with the digital twin simulation.

9. The computer system of claim 8, the method further comprising:
based on determining the propagation pattern does not result in the accumulated snow failing to fall:
causing the one or more second devices to generate the heat at the location of the one or more cracks at the first heating level in accordance with the digital twin simulation.

10. The computer system of claim 9, the method further comprising:
based on determining the propagation pattern does result in the accumulated snow failing to fall, iterating, until the propagation pattern does not result in the accumulated snow failing to fall:
executing an updated digital twin simulation where at least one operational parameter of at least one device of the one or more first devices and the one or more second devices is modified.

11. The computer system of claim 10, wherein modifying the at least one operational parameter further comprises:
changing the first energy level to a second energy level and changing the first heating level to a second heating level.

12. The computer system of claim 8, the method further comprising:
causing the one or more solar panels to retract from the maximum orientation angle to the orientation angle based on determining the accumulated snow has fallen from the one or more solar panels.

13. The computer system of claim 8, wherein the generated one or more cracks in the accumulated snow are discontinuous cracks.

14. The computer system of claim 8, wherein the one or more first devices include a plurality of swarm drones and the one or more second devices include an infrared (IR) heater.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources in a solar panel environment;
computing an amount of snow accumulation on one or more solar panels based on the real-time data;
causing an orientation angle of the one or more solar panels to change to a maximum orientation angle based on the amount of snow accumulation;
executing a digital twin simulation of a first digital twin model of one or more first devices generating one or more cracks in an accumulated snow by emitting a laser beam on one or more portions of the one or more solar panels at a first energy level and a second digital twin model of one or more second devices generating heat at a location of the one or more cracks at a first heating level based on the historical data;
determining whether a propagation pattern of the one or more cracks results in the accumulated snow failing to fall from at least one solar panel of the one or more solar panels; and
based on determining the propagation pattern does not result in the accumulated snow failing to fall:
causing the one or more first devices to generate the one or more cracks in the accumulated snow on the one or more portions of the one or more solar panels by emitting the laser beam at the first energy level in accordance with the digital twin simulation.

16. The computer program product of claim 15, the method further comprising:
based on determining the propagation pattern does not result in the accumulated snow failing to fall:
causing the one or more second devices to generate the heat at the location of the one or more cracks at the first heating level in accordance with the digital twin simulation.

17. The computer program product of claim 16, further comprising:
based on determining the propagation pattern does result in the accumulated snow failing to fall, iterating, until the propagation pattern does not result in the accumulated snow failing to fall:
executing an updated digital twin simulation where at least one operational parameter of at least one device of the one or more first devices and the one or more second devices is modified.

18. The computer program product of claim 17, wherein modifying the at least one operational parameter further comprises:
changing the first energy level to a second energy level and changing the first heating level to a second heating level.

19. The computer program product of claim 15, the method further comprising:
causing the one or more solar panels to retract from the maximum orientation angle to the orientation angle based on determining the accumulated snow has fallen from the one or more solar panels.

20. The computer program product of claim 15, wherein the generated one or more cracks in the accumulated snow are discontinuous cracks.
